(19) United States
(12) Patent Application Publication
(10) Pub. No.: US 2019/0323405 A1
(43) Pub. Date: Oct. 24, 2019

(54) GASOLINE PARTICULATE FILTER FILTRATION EFFICIENCY IMPROVEMENT WITH ENGINE CONTROL

(71) Applicants: Brett Schubring, Macomb, MI (US); Brian E. Hallgren, Milford, MI (US); Luis J. Del Rio, Ann arbor, MI (US); Jeffrey P. Wuttke, Sterling Heights, MI (US); Jordan E. Easter, Ann Arbor, MI (US)

(72) Inventors: Brett Schubring, Macomb, MI (US); Brian E. Hallgren, Milford, MI (US); Luis J. Del Rio, Ann arbor, MI (US); Jeffrey P. Wuttke, Sterling Heights, MI (US); Jordan E. Easter, Ann Arbor, MI (US)

(21) Appl. No.: 16/014,731

(22) Filed: Jun. 21, 2018

Related U.S. Application Data
(60) Provisional application No. 62/661,937, filed on Apr. 24, 2018.

(51) Int. Cl. F01N 9/00; F02D 41/02; F01N 3/029

(52) U.S. Cl. CPC F01N 9/002; F01N 9/005; F02D 41/029; F02D 2200/0802; F01N 2900/1606; F02D 2200/0812; F01N 3/029

(57) ABSTRACT

An exhaust treatment system configured to treat exhaust gas produced by an engine of a vehicle and its method of operation involve providing a gasoline particulate filter (GPF) configured to trap particulate matter (PM) in the exhaust gas and a utilizing a controller configured to determine a modeled PM load level on the GPF and, based on the modeled PM load level of the GPF, control operation of the engine to maintain at least a minimum PM load level on the GPF, wherein the minimum PM load level is greater than zero and corresponds to an optimized efficiency of the GPF.

### CROSS-REFERENCE TO RELATED APPLICATION

This application claims benefit of U.S. Provisional Application Ser. No. 62/661,937 filed on Apr. 24, 2018. The disclosure of the above application is incorporated herein by reference in its entirety.

### FIELD

The present application generally relates to exhaust treatment systems and, more particularly, to techniques for improving gasoline particulate filter (GPF) filtration efficiency with engine control.

### BACKGROUND

An exhaust treatment system treats exhaust gas produced by an engine of a vehicle to mitigate or eliminate emissions. One component of exhaust gas is particulate matter (PM), such as ash or soot. Gasoline direct injection (GDI) engines tend to produce more PM than port fuel injection (PFI) gasoline engines. A gasoline particulate filter (GPF) is a component of an exhaust treatment system that traps and stores the PM in the exhaust gas to decrease PM emissions. The stored PM is periodically oxidized or burnt off, thereby mitigating or eliminating PM emissions. Past gasoline engine vehicles have been able to meet PM emissions targets without the use of GPFs. Due to very recent government regulations, however, GPFs are often necessary to be able to meet more strict PM emissions targets. Accordingly, there exists an opportunity for the improvement of control strategies for vehicles equipped with GPFs.

### SUMMARY

According to one example aspect of the invention, an exhaust treatment system configured to treat exhaust gas produced by an engine of a vehicle is presented. In one exemplary implementation, the system comprises a gasoline particulate filter (GPF) configured to trap particulate matter (PM) in the exhaust gas and a controller configured to: determine a modeled PM load level on the GPF and, based on the modeled PM load level of the GPF, control operation of the engine to maintain at least a minimum PM load level on the GPF, wherein the minimum PM load level is greater than zero and corresponds to an optimized efficiency of the GPF.

In some implementations, the controller is further configured to maintain at least the minimum PM load level on the GPF by limiting or disabling a deceleration fuel shutoff (DFSO) event of the engine. In some implementations, the controller is configured to maintain at least the minimum PM load level on the GPF by limiting or disabling the DFSO event of the engine only when a temperature of the GPF is greater than a temperature threshold. In some implementations, the temperature threshold is approximately 550 degrees Celsius.

In some implementations, the controller is further configured to control the engine to perform a DFSO event whereby oxygen is introduced into the exhaust gas to oxidize and burn off the PM trapped by the GPF and upon completion of the DFSO event: control the engine such that the exhaust gas has a rich fuel/air (FA) ratio to remove or purge oxygen from a three-way catalytic (TWC) converter upstream from the GPF, and while controlling the engine such that the exhaust gas has a rich FA ratio, maintain at least the minimum PM load level on the GPF by adjusting a fueling parameter such that the engine produces elevated levels of PM. In some implementations, the fueling parameter is fuel pressure. In some implementations, the fueling parameter is fuel injection timing.

In some implementations, the controller is configured to maintain at least the minimum PM load level on the GPF by adjusting the fueling parameter such that the engine produces elevated levels of PM only when a temperature of the GPF is greater than a temperature threshold. In some implementations, the temperature threshold is approximately 550 degrees Celsius. In some implementations, the controller is configured to determine the modeled PM load level on the GPF based on at least one of engine coolant temperature, engine speed, and engine load.

According to another example aspect of the invention, a method of operating an engine of a vehicle to increase an efficiency of a GPF in an exhaust treatment system of the vehicle is presented. In one exemplary implementation, the method comprises determining, by a controller, a modeled PM load level on the GPF and, based on the modeled PM load level of the GPF, controlling, by the controller, operation of the engine to maintain at least a minimum PM load level on the GPF, wherein the minimum PM load level is greater than zero and corresponds to an optimized efficiency of the GPF.

In some implementations, maintaining at least the minimum PM load level on the GPF comprises limiting or disabling, by the controller, a DFSO event of the engine. In some implementations, maintaining at least the minimum PM load level on the GPF comprises limiting or disabling, by the controller, the DFSO event of the engine only when a temperature of the GPF is greater than a temperature threshold. In some implementations, the temperature threshold is approximately 550 degrees Celsius.

In some implementations, the method further comprises controlling, by the controller, the engine to perform a DFSO event whereby oxygen is introduced into the exhaust gas to oxidize the PM trapped by the GPF and upon completion of the DFSO event: controlling, by the controller, the engine such that the exhaust gas has a rich fuel/air (FA) ratio to remove or purge oxygen from a three-way catalytic (TWC) converter upstream from the GPF and, while controlling the engine such that the exhaust gas has a rich FA ratio, maintaining, by the controller, at least the minimum PM load level on the GPF by adjusting, by the controller, a fueling parameter such that the engine produces elevated levels of PM. In some implementations, the fueling parameter is fuel pressure. In some implementations, the fueling parameter is fuel injection timing.

In some implementations, maintaining at least the minimum PM load level on the GPF comprises by adjusting the fueling parameter such that the engine produces elevated levels of PM only when a temperature of the GPF is greater than a temperature threshold. In some implementations, the temperature threshold is approximately 550 degrees Celsius. In some implementations, determining the modeled PM load level on the GPF is based on at least one of engine coolant temperature, engine speed, and engine load.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses, Thus, variations that do not depart from the gist of the present disclosure are intended to be within the scope of the present disclosure.

### BRIEF DESCRIPTION OF THE DRAWINGS

FIG. 1 is a diagram of an example vehicle comprising an engine and an exhaust system with a gasoline particulate filter (GPF) according to the principles of the present disclosure; and

FIG. 2 is a flow diagram of an example method of improving GPF filtration efficiency with engine control according to the principles of the present disclosure.

### DESCRIPTION

As discussed above, there exists an opportunity for the improvement of control strategies for vehicles equipped with gasoline particulate filters (GPFs). In conventional operation, all of the stored particulate matter (PM) in a GPF is typically oxidized or burnt off during a deceleration fuel shutoff (DFSO) event. A zero PM load GPF, however, does not produce optimal filtration efficiency. Rather, there is some minimal PM load level for the GPF that results in optimal filtration efficiency. Accordingly, techniques are presented for improved GPF filtration efficiency using engine control. These techniques determine a modeled PM load level on the GPF and then, based on the modeled PM load level, control operation of the engine to maintain at least a non-zero minimum PM load level on the GPF. In one exemplary implementation, the modeled PM load level is determined based on at least one of engine coolant temperature, engine speed, and engine load.

In one implementation, the techniques maintain at least the minimum PM load level on the GPF by limiting or disabling deceleration fuel shutoff (DFSO) events of the engine. This could be performed, for example, only when a temperature of the GPF is greater than a temperature threshold. (e.g., ˜550 degrees Celsius). In another implementation, the techniques control the engine to perform a DFSO event whereby oxygen is introduced into the exhaust gas to oxidize the PM trapped by the GPF. In such an implementation, after the DFSO event, the techniques control the engine (e.g., run the engine rich) such that the exhaust gas has a rich fuel/air (FA) ratio in order to remove or purge oxygen stored by a three-way catalytic (TWC) converter upstream from the GPF. This also provides an opportunity to change one or more fueling parameters such that additional PM is produced by the engine and at least the minimum PM load level on the GPF is maintained for optimal conversion efficiency. This could be performed, for example, by controlling fuel pressure and/or fuel injection timing. This could also be performed, for example, only when the temperature of the GPF is greater than a temperature threshold. (e.g., ˜550 degrees Celsius).

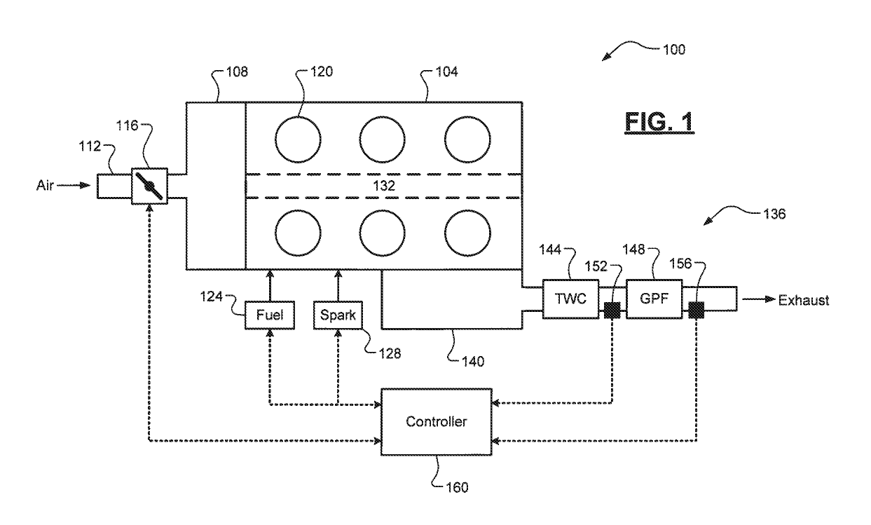

Referring now to FIG. 1, a diagram of an example vehicle 100 is illustrated. The vehicle 100 includes an engine 104 that draws air into an intake manifold 108 through an induction system 112 that is regulated by a throttle valve 116. It will be appreciated that the engine 104 could further include a forced induction system (not shown), such as a turbocharger or a supercharger, for increasing engine airflow to increase its output torque. The air in the intake manifold 108 is distributed to a plurality of cylinders 120 and combined with liquid gasoline from fuel injectors 124 (e.g., direct fuel injection or port fuel injection) to form an air/fuel mixture. While six cylinders are shown, it will be appreciated that the engine 104 could include any suitable number of cylinders (four cylinders, eight cylinders, etc.). The air/fuel mixture is compressed by pistons (not shown) within the cylinders 120 and ignited by spark plugs 128. The combustion of the compressed air/fuel mixture drives the pistons (not shown), which rotatably drive a crankshaft 132 to generate drive torque that is utilized to propel the vehicle 100.

Exhaust gas resulting from combustion is expelled from the cylinders 120 into an exhaust system 136. The exhaust system 136 treats the exhaust gas to decrease or eliminate emissions. The exhaust system 136 includes an exhaust manifold 140 followed downstream by a TWC converter 144 (“TWC 144”) and a GPF 148. The TWC 144 operates to treat the exhaust gas to decrease nitrogen oxide (NOx), hydrocarbon (HC), and carbon monoxide (CO) emissions. The GPF 148 operates to traps/store PM to decrease PM emissions. Temperature sensors 152, 156 measure a temperature of the exhaust gas upstream and downstream from the GPF 148, respectively. A controller 160 controls operation of the vehicle 100, including controlling air/fuel/spark via the throttle valve 116, the fuel injectors 124, and the spark plugs 128 to generate a desired drive torque at the crankshaft 132. The controller 160 also receives the measured upstream and downstream temperatures from temperature sensors 152, 156. The controller 160 is also configured to perform at least some of the aspects of the engine control techniques described herein, which will now described in greater detail.

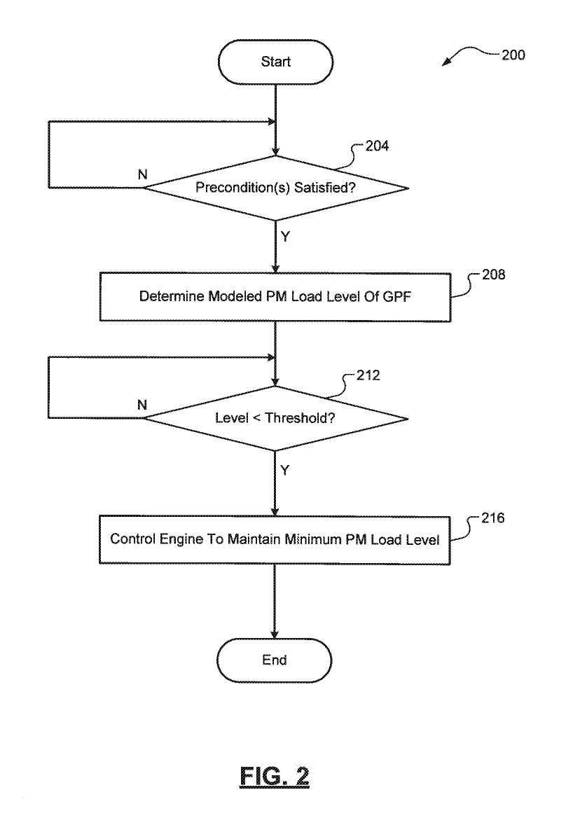

Referring now to FIG. 2, a flow diagram of a method 200 for improving GPF filtration efficiency using engine control is illustrated. At 204, the controller 160 determines whether a set of one or more preconditions are satisfied. Non-limiting example preconditions include the engine 104 is currently running, the exhaust gas temperature is greater than a predetermined threshold (e.g., ˜550 degrees Celsius), and a DFSO event has recently occurred. It will be appreciated that other suitable preconditions could be required, such as the engine 104 currently running in a particular operating mode that is suitable for the engine control techniques described herein. At 208, the controller 160 determines a modeled PM load level on the GPF 148. In one exemplary implementation, the controller 160 models the PM load level on the GPF 148 based on at least one of engine temperature (e.g., engine coolant temperature), engine speed, and engine load. It will be appreciated that fewer or additional other suitable parameters could be utilized in the modeling of the PM load level. This model could be generated based on predetermined calibration data (e.g., collected via dynamometer testing). It will also be appreciated that a PM sensor could be implemented to measure the PM load level on the GPF 148, but these sensors are typically expensive.

At 212, the controller 160 determines whether the modeled PM load level on the GPF 148 is less than a predetermined threshold. This threshold, for example, could correspond to an optimal filtration efficiency of the GPF 148. When true, the method 200 proceeds to 216. When false, the method 200 ends or returns to 204. At 216, the controller 160 controls the engine 104 to maintain a minimum PM load level for optimal filtration efficiency of the GPF 148 (e.g., the predetermined threshold). For example, this engine control could include the controller 160 limiting or disabling DFSO events, which oxidize the trapped/stored PM on the GPF 148 and could decrease its PM load level below the predetermined threshold. Not all DFSO events may need to be limited or disabled. Rather, only enough DFSO operation needs to be limited or disabled such that the PM load level on the GPF 148 increases to at least the minimum PM load level for optimal filtration efficiency (e.g., the predetermined threshold). Additionally or alternatively, for example, this engine control could include the controller 160 adjusting fuel injection pressure and/or fuel injection timing such that the engine 104 temporarily produces additional PM to increase the PM load level on the GPF 148. After 216, the method 200 then ends or returns to 200.

It should be understood that this detailed description, including disclosed embodiments and figures, are merely exemplary in nature intended for purposes of illustration only and are not intended to limit the scope of the present disclosure, its application or uses. Thus, variations that do not depart from the gist of the present disclosure are intended to be within the scope of the present disclosure.

It will be appreciated that the term controller as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An exhaust treatment system configured to treat exhaust gas produced by an engine of a vehicle, the system comprising:
a gasoline particulate filter (GPF) configured to trap particulate matter (PM) in the exhaust gas; and
a controller configured to:
determine a modeled PM load level on the GPF; and
based on the modeled PM load level of the GPF, control operation of the engine to maintain at least a minimum PM load level on the GPF,
wherein the minimum PM load level is greater than zero and corresponds to an optimized efficiency of the GPF.

2. The system of claim 1, wherein the controller is further configured to maintain at least the minimum PM load level on the GPF by limiting or disabling a deceleration fuel shutoff (DFSO) event of the engine.

3. The system of claim 2, wherein the controller is configured to maintain at least the minimum PM load level on the GPF by limiting or disabling the DFSO event of the engine only when a temperature of the GPF is greater than a temperature threshold.

4. The system of claim 3, wherein the temperature threshold is approximately 550 degrees Celsius.

5. The system of claim 1, wherein the controller is further configured to:
control the engine to perform a deceleration fuel shutoff (DFSO) event whereby oxygen is introduced into the exhaust gas to oxidize and burn off the PM trapped by the GPF; and
upon completion of the DFSO event:
control the engine such that the exhaust gas has a rich fuel/air (FA) ratio to remove or purge oxygen from a three-way catalytic (TWC) converter upstream from the GPF; and
while controlling the engine such that the exhaust gas has a rich FA ratio, maintain at least the minimum PM load level on the GPF by adjusting a fueling parameter such that the engine produces elevated levels of PM.

6. The system of claim 5, wherein the fueling parameter is fuel pressure.

7. The system of claim 5, wherein the fueling parameter is fuel injection timing.

8. The system of claim 5, wherein the controller is configured to maintain at least the minimum PM load level on the GPF by adjusting the fueling parameter such that the engine produces elevated levels of PM only when a temperature of the GPF is greater than a temperature threshold.

9. The system of claim 8, wherein the temperature threshold is approximately 550 degrees Celsius.

10. The system of claim 1, wherein the controller is configured to determine the modeled PM load level on the GPF based on at least one of engine coolant temperature, engine speed, and engine load.

11. A method of operating an engine of a vehicle to increase an efficiency of a gasoline particulate filter (GPF) in an exhaust treatment system of the vehicle, the method comprising:
determining, by a controller, a modeled particulate matter (PM) load level on the GPF; and
based on the modeled PM load level of the GPF, controlling, by the controller, operation of the engine to maintain at least a minimum PM load level on the GPF,
wherein the minimum PM load level is greater than zero and corresponds to an optimized efficiency of the GPF.

12. The method of claim 11, wherein maintaining at least the minimum PM load level on the GPF comprises limiting or disabling, by the controller, a deceleration fuel shutoff (DFSO) event of the engine.

13. The method of claim 12, wherein maintaining at least the minimum PM load level on the GPF comprises limiting or disabling, by the controller, the DFSO event of the engine only when a temperature of the GPF is greater than a temperature threshold.

14. The method of claim 13, wherein the temperature threshold is approximately 550 degrees Celsius.

15. The method of claim 11, further comprising:
controlling, by the controller, the engine to perform a deceleration fuel shutoff (DFSO) event whereby oxygen is introduced into the exhaust gas to oxidize the PM trapped by the GPF; and
upon completion of the DFSO event:
controlling, by the controller, the engine such that the exhaust gas has a rich fuel/air (FA) ratio to remove or purge oxygen from a three-way catalytic (TWC) converter upstream from the GPF; and
while controlling the engine such that the exhaust gas has a rich FA ratio, maintaining, by the controller, at least the minimum PM load level on the GPF by adjusting, by the controller, a fueling parameter such that the engine produces elevated levels of PM.

16. The method of claim 15, wherein the fueling parameter is fuel pressure.

17. The method of claim 15, wherein the fueling parameter is fuel injection timing.

18. The method of claim 15, wherein maintaining at least the minimum PM load level on the GPF comprises by adjusting the fueling parameter such that the engine produces elevated levels of PM only when a temperature of the GPF is greater than a temperature threshold.

19. The method of claim 18, wherein the temperature threshold is approximately 550 degrees Celsius.

20. The method of claim 11, wherein determining the modeled PM load level on the GPF is based on at least one of engine coolant temperature, engine speed, and engine load.
